(19) United States
(12) Patent Application Publication
(10) Pub. No.: US 2024/0335773 A1
(43) Pub. Date: Oct. 10, 2024

(54) SCREEN FILTER SUCTION NOZZLE

(71) Applicant: NETAFIM, LTD., TEL AVIV (IL)

(72) Inventor: AMIT GILBOA, KIBBUTZ SDOT YAM (IL)

(73) Assignee: NETAFIM, LTD., TEL AVIV (IL)

(21) Appl. No.: 18/747,515

(22) Filed: Jun. 19, 2024

Related U.S. Application Data
(63) Continuation-in-part of application No. PCT/IB2022/062094, filed on Dec. 12, 2022.
(60) Provisional application No. 63/293,093, filed on Dec. 23, 2021.

(51) Int. Cl. B01D 29/64; B01D 29/11

(52) U.S. Cl. CPC B01D 29/6453; B01D 29/117; B01D 2201/082

(57) ABSTRACT

A suction nozzle for a screen filter has an inlet orifice at its distal side through which liquid is arranged to flow into the nozzle during a cleaning operation. The orifice has a longitudinal extension and a width of the orifice changes along its longitudinal extension.

### RELATED APPLICATIONS

This is a Bypass Continuation-in-Part of PCT/IB2022/062094, filed 12 Dec. 2022 and published as WO 2023/119055A1. Priority is claimed to U.S. Provisional Patent Application No. 63/293,093 filed 23 Dec. 2021. The contents of the above-mentioned applications are incorporated by reference in their entirety.

### TECHNICAL FIELD

Embodiments of the invention relate to a screen filter suction nozzle, and in particular to an orifice that is used for regulating the flow of liquid into the suction nozzle.

### BACKGROUND

An irrigation screen filter is a type of water filtration device that uses a screen to separate dirt out of water that is used for irrigation. Screen filters typically require periodic cleaning to maintain their filtering efficiency, and a common cleaning method is to apply suction to the screen via suction nozzles.

The suction nozzles are used for evacuating debris and dirt from the screen surface by suction action, and the suction force is proportional to the suction speed. Therefore, for a given suction flow rate, the smaller the orifice of the suction nozzle, the higher the suction speed and hence the suction force and cleaning efficiency.

Other criteria that determine the functionality of the suction nozzle is the maximal dirt size particle that can pass into the nozzle and hence be evacuated from the screen surface. This size is determined by the smallest passage in the nozzle (usually at the orifice of the suction nozzle).

Effective suction width is yet another criterion that determines the functionality of the suction nozzle. Since the array of nozzles being used for cleaning do not cover the full screen surface, active scanning should be performed across the screen surface.

Such scanning of the screen is performed by movement of the nozzle across the screen, in such a way that its path of movement covers the full screen surface. Nozzle movement interval is defined by the nozzle effective scan width. The wider the nozzle is—the fewer scanning steps are required in order to cover the full screen surface.

As a result, a conflict may arise between the above-mentioned criteria. While the ability to evacuate large debris requires large passage nozzle openings and the ability to scan the screen surface effectively requires wide nozzles—the ability to maintain high suction speed requires small nozzles.

### SUMMARY

The following embodiments and aspects thereof are described and illustrated in conjunction with systems, tools and methods which are meant to be exemplary and illustrative, not limiting in scope.

In an embodiment there is provided a suction nozzle for a screen filter comprising an inlet orifice at its distal side through which liquid is arranged to flow into the nozzle during a cleaning operation, the orifice having a longitudinal extension, wherein a width of the orifice changes along its longitudinal extension.

Possibly, changes along the longitudinal extension of an orifice are step like changes.

Possibly, changes along the longitudinal extension of an orifice are gradual changes.

The orifice may be designed to comprise primary and secondary sections where the width of the orifice is, respectively, wider and narrower. That is to say, a primary section is wider than an adjoining secondary section.

In some cases, all primary sections may have a substantially similar width and/or all secondary sections may have a substantially similar width, where, for example, up to about 5% or in some embodiments up to about 10% difference in width may be determined in some cases as being substantially similar.

In certain cases, the orifice is arranged along its longitudinal extension in a symmetric manner placing e.g., two secondary sections on opposing sides of a central primary section—or two primary sections on opposing sides of a central secondary section.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a perspective view of a screen filter in accordance with the present invention;

FIG. 2 schematically shows a partial cross-sectional view of the screen filter of FIG. 1; and

FIG. 3 schematically shows various cross-sectional shapes of suction nozzle orifices in accordance with the various embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

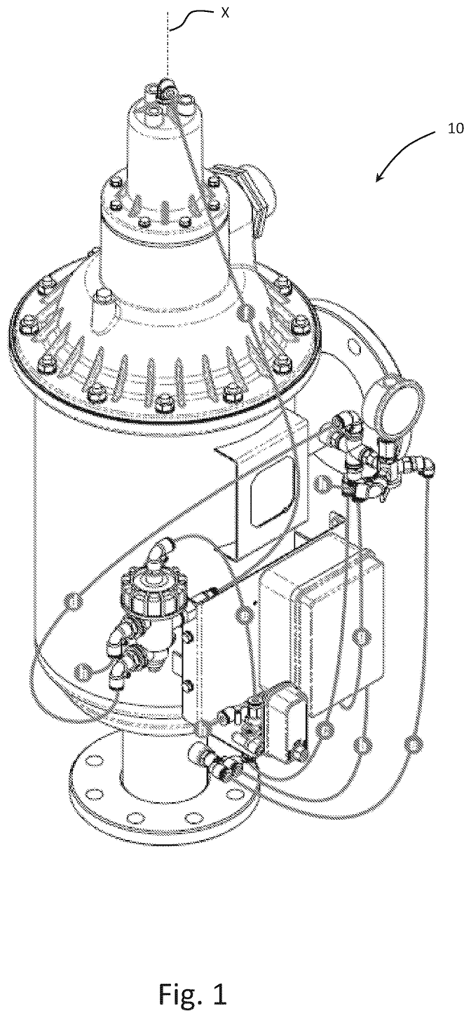

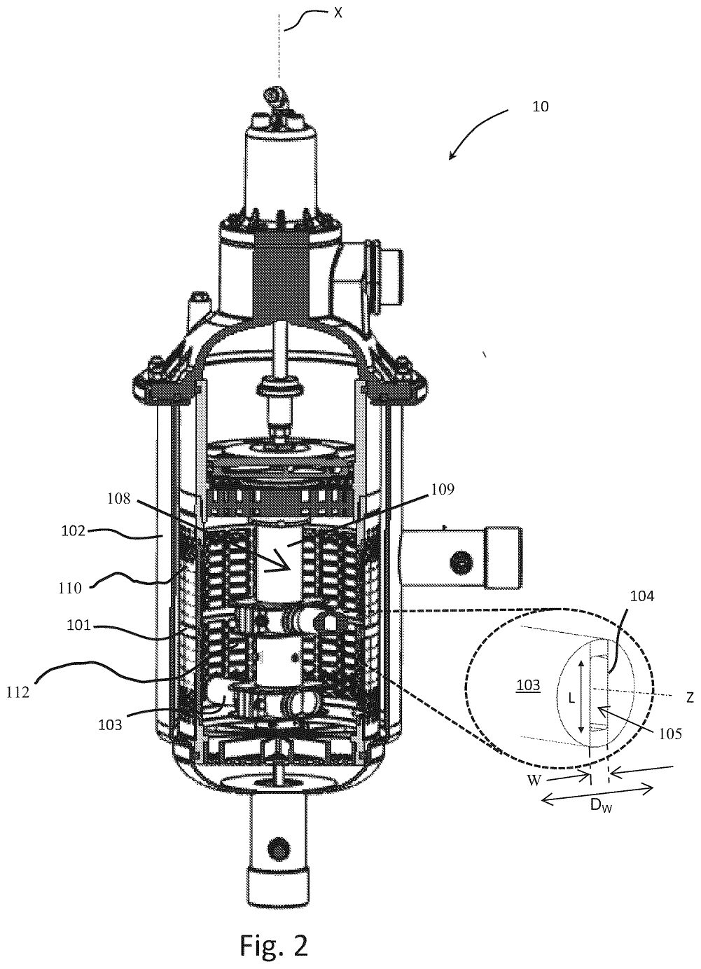

Attention is first drawn to FIG. 1 showing a screen filter 10 in accordance with an embodiment of the present invention that is generally formed about a filter axis X. Hydraulic lines indicated ‘a’ to ‘h’ provide liquid pressurized communication needed for controlling and operating the filter. Such control and operation of the filter includes activation of a reciprocating cleaning operation along the filter axis X of a screen of the filter (seen in FIG. 2) that is formed about the filter axis X.

Attention is drawn to FIG. 2 showing a cross sectional view of the filter 10 taken along a plane that is parallel to the filter axis X. A screen 101 of the filter that is formed about the filter axis X defines relative inner and outer regions that are formed within an exterior housing 102 of the filter 10. The outer region 110 is formed between screen 101 and exterior housing 102 of the filter. The inner region 112 is formed at an inner side of the screen. It is understood that the screen 101 may have a cylindrical shape and thus be considered a cylindrical screen, such as those known in the art.

In a filtering operation of the filter, liquid flows from the inner region towards the outer region via the screen where dirt is removed from the liquid on the inner side of the screen.

The filter 10 includes a cleaning assembly 108 comprising a central rod 109 and one or more suction nozzles 103 attached to the central rod 109. The suction nozzles 103 are directly radially outward from the central rod 109 to face the screen 101. In some embodiments, the suction nozzles 103 may be axially spaced apart from one another along the filter axis X. In some embodiments, axially spaced apart suction nozzles 103 may face in different circumferential directions. In some embodiments, a plurality of suction nozzle 103 may be provided on the central rod 109 at the same axial position along the filter axis X, each such nozzle facing in a different circumferential direction.

The central rod 109 is hollow and the suction nozzles 103 are configured to communicate with the interior of the central rod 109. The central rod 109 is connected to a source of negative pressure for applying a suction. During a cleaning cycle, the suction nozzles 103 suck in and convey dirt to an interior of the central rod 109. From the interior of the central rod 109, the dirt is removed the housing 102. In some embodiments, the dirt is directed to a waste tank. In other embodiments, the dirt is released to the ambient environment.

The cleaning assembly 108 of the filter can be activated by a driving assembly (not shown) comprising a motor coupled to one or more threaded screws, gears, or the like, which are operatively engaged to the central rod 109. During a cleaning operation of the filter 10, the cleaning assembly 108 is activated to urge suction nozzles 103 to move in a reciprocating manner back and forth along filter axis X while simultaneously rotating about the same filter axis X. This motion urges formation of helical cleaning paths that are created by each suction nozzle 103 along the inner side of the screen 101.

Each suction nozzle 103 extends in a radial outer direction towards the screen 101 along a respective central nozzle axis Z. In the enlarged section at the right-hand side of FIG. 2, a radial outer side of a suction nozzle 103 is seen including an orifice 104 through which the suction nozzle 103 opens out towards the screen 101. Thus, each suction nozzle 103 has an internal passageway 105 that terminates in an orifice 104 through which the suction nozzle opens out towards the screen.

Each orifice 104 has a longitudinal extension L that extends generally parallel to the filter axis X.

Each orifice 104 also has a width W measured in a width direction D_{w} which is perpendicular to longitudinal extension L and also to the filter axis X.

In some embodiments, the longitudinal extension L is larger than the width W of the orifice by a factor of at least three.

Each central nozzle axis Z may be located midway along the longitudinal extension L of a given orifice 104. Each nozzle axis Z may extend perpendicular to both the longitudinal extension L and the width direction D_{w} of a given orifice 104 and be located at the center of that orifice 104. Each nozzle axis Z may be oriented perpendicular to the filter axis X.

In some embodiments, each the suction nozzle 103 has monolithic construction (unitary, one-piece construction) from the orifice 104 and along the central nozzle axis Z to where the suction nozzle attaches to the remainder of the cleaning assembly.

In some embodiments, cross-sections of the suction nozzle 103 taken perpendicular to the central nozzle axis Z, the internal passageway 105 has a constant cross-sectional shape which matches the shape of the orifice 104, for at least 50% of the length of the suction nozzle 103. In other words, the passageway 105 maintains the same shape as the orifice for at least half the length of the suction nozzle. This provides sufficient traveling distance along the fluid passageway 105 for larger dirt particles to become properly oriented as they travel within the passageway 105 to eventually be removed during the cleaning process.

During a cleaning operation, liquid flows into each suction nozzle 103 via its respective orifice 104, which is located adjacent the inner side 112 of the screen 101 in order to suck and thus clean the screen 101 from dirt that accumulated on it during the preceding filtering phase of the filter.

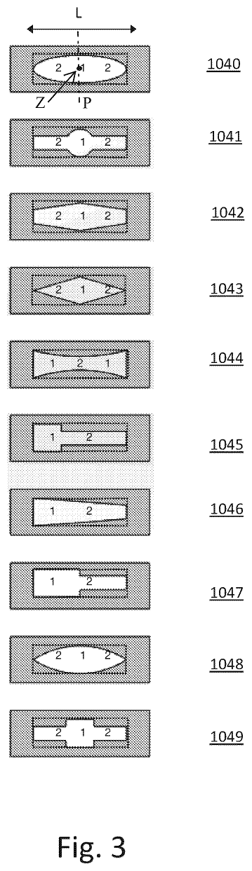

The orifice seen in FIG. 2 is of a known type where a width W of the orifice 104 along its longitudinal extension L is generally identical. With attention drawn to FIG. 3, various orifice types used in suction nozzle embodiments of the present invention are shown. Each one of the orifice types is shown enclosed within a ‘dotted’ rectangle resembling the known type seen in FIG. 2.

Each of the orifice embodiments of FIG. 3 has non-circular and non-rectangular shapes. Each one of the orifice embodiments of FIG. 3 can be seen comprising primary sections 1 along their longitudinal extensions where they are wider and secondary sections 2 where they are narrower.

The primary sections 1 are suited for sucking dirt particles of larger size, while the secondary sections 2 are configured for higher suction speeds and hence suction force that is suited for higher cleaning efficiency.

Orifices 1040, 1041, 1042, 1043, 1048 and 1049 can be seen being symmetrically formed to include two secondary sections 2 symmetrically formed on opposing sides of a central primary section 1. Orifices 1040, 1041, 1042, 1043, 1048 and 1049 may be mirror symmetric about an imaginary plane P perpendicular to the longitudinal extension L and containing the nozzle axis Z. In addition, these orifices may exhibit rotational symmetry about the nozzle axis Z.

Orifices 1041 and 1049 can be seen being formed with all primary sections defining a constant first width and all secondary sections defining a constant second width.

Orifices 1045, 1046 and 1047 can be seen being formed in a non-symmetric manner to include primary 1 and secondary 2 sections one aside the other. These orifices 1045, 1046 and 1047 may lack both mirror symmetry about such an imaginary plane P, and rotational symmetry about the nozzle axis Z.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. A screen filter having a filter axis (X), and comprising:
an outer housing extending along the filter axis (X);
a screen located in the outer housing and configured for removing dirt from liquid flowing through the outer housing, the screen being formed about the filter axis (X); and
a cleaning assembly for cleaning the screen, the cleaning assembly comprising:
one or more suction nozzles arranged for reciprocating movement back and forth along the filter axis (X) while simultaneously rotating about said filter axis (X), each suction nozzle comprising an internal passageway terminating in an orifice through which the suction nozzle opens out towards the screen;
wherein:
each orifice has a longitudinal extension (L) extending parallel to the filter axis (X), a radially directed central nozzle axis (Z) perpendicular to the longitudinal extension (L); and
a width (W) of the orifice changes along its longitudinal extension (L).

2. The screen filter of claim 1, wherein each orifice comprises a primary section adjoining a secondary section, the primary section being wider than the secondary section.

3. The screen filter of claim 2, wherein along its longitudinal extension, the orifice comprises a centrally located primary section adjoining first and second secondary sections, one on either side of the primary section.

4. The screen filter of claim 3, wherein the orifice is stepped along its longitudinal extension, with the primary section having a constant first width and the first and second secondary sections having constant second width.

5. The screen filter of claim 2, wherein along its longitudinal extension, the orifice comprises a centrally located secondary section adjoining first and second primary sections, one on either side of the secondary section.

6. The screen filter of claim 5, wherein the orifice is stepped along its longitudinal extension, with the secondary section having a constant second width and the first and second primary sections having constant first width.

7. The screen filter of claim 2, wherein along its longitudinal extension, the orifice comprises a single primary section and a single secondary section.

8. The screen filter of claim 7, wherein the orifice is stepped along its longitudinal extension, with the single primary section having a constant first width and the single secondary section having a constant second width.

9. The screen filter of claim 2, wherein all primary sections in an orifice define a substantially similar first width and all secondary sections in an orifice define a substantially similar second width.

10. The screen filter of claim 1, wherein:
in cross-sections of the suction nozzle taken perpendicular to the central nozzle axis (Z), the internal passageway has a constant cross-sectional shape matching that of the orifice, for at least 50% of the length of the suction nozzle.

11. A screen filter suction nozzle comprising:
an internal passageway terminating in an orifice, the orifice having a longitudinal extension (L), a width (W) measured along a width direction (D_{w}) perpendicular to the longitudinal extension (L), and a central nozzle axis (Z) perpendicular to both longitudinal extension (L) and the width direction (D_{w});
wherein:
the width (W) of the orifice changes along its longitudinal extension (L); and
in cross-sections of the suction nozzle taken perpendicular to the central nozzle axis (Z), the internal passageway has a constant cross-sectional shape matching that of the orifice, for at least 50% of the length of the suction nozzle.

12. The screen filter suction nozzle of claim 11, wherein each orifice comprises a primary section adjoining a secondary section, the primary section being wider than the secondary section.

13. The screen filter suction nozzle of claim 12, wherein along its longitudinal extension, the orifice comprises a centrally located primary section adjoining first and second secondary sections, one on either side of the primary section.

14. The screen filter suction nozzle of claim 13, wherein the orifice is stepped along its longitudinal extension, with the primary section having a constant first width and the first and second secondary sections having constant second width.

15. The screen filter suction nozzle of claim 12, wherein along its longitudinal extension, the orifice comprises a centrally located secondary section adjoining first and second primary sections, one on either side of the secondary section.

16. The screen filter suction nozzle of claim 15, wherein the orifice is stepped along its longitudinal extension, with the secondary section having a constant second width and the first and second primary sections having constant first width.

17. The screen filter suction nozzle of claim 12, wherein along its longitudinal extension, the orifice comprises a single primary section and a single secondary section.

18. The screen filter suction nozzle of claim 17, wherein the orifice is stepped along its longitudinal extension, with the single primary section having a constant first width and the single secondary section having a constant second width.

19. The screen filter suction nozzle of claim 18, wherein the orifice is stepped along its longitudinal extension, with the single primary section having a constant first width and the single secondary section having a constant second width.

20. The screen filter suction nozzle of claim 12, wherein all primary sections in an orifice define a substantially similar first width and all secondary sections in an orifice define a substantially similar second width.
